(19) United States
(12) Patent Application Publication
(10) Pub. No.: US 2006/0278722 A1
(43) Pub. Date: Dec. 14, 2006

(54) Semiconductor device, method of manufacturing the same, and information managing system for the same

(75) Inventor: Tetsuro Tominaga, Kita-Kyushu-Shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/448,909

(22) Filed: Jun. 8, 2006

(30) Foreign Application Priority Data
Jun. 13, 2005 (JP) 2005-172618

(51) Int. Cl. G06K 19/06

(52) U.S. Cl. 235/492

(57) ABSTRACT

A semiconductor device according to an aspect of the present invention includes: a first region in which an integrated circuit is formed; and a second region in which a plurality of patterns formed by dividing a two-dimensional code of ID information are imprinted.

### CROSS-REFERENCE TO RELATED APPLICATION

This application is based upon and claims the benefit of priority from prior Japanese Patent Application No. 2005-172618 filed on Jun. 13, 2005 in Japan, the entire contents of which are incorporated herein by reference.

### BACKGROUND OF THE INVENTION

In recent years, an ID mark that indicates information such as a production lot number, the number allotted to the semiconductor wafer used, and the location of the chip on the semiconductor wafer is attached to each semiconductor chip, so as to give traceability to the production history in each semiconductor device.

As the ID mark, a two-dimensional code that can contain a large amount of data is preferable. However, a two-dimensional code requires a large area in which the two-dimensional code can be solely imprinted (see Japanese Patent Application Laid-open No. 5-315207, for example).

The semiconductor device disclosed in Japanese Patent Application Laid-open No. 5-315207 has a square-shaped information recording region surrounding the region in which an integrated circuit is formed in each of the semiconductor chips formed in a lattice-like shape on the principal face of a semiconductor wafer.

In this information recording region, a two-dimensional code in which the number allotted to the semiconductor wafer, the chip location identification number in the semiconductor wafer, and the other production history information are recorded in the form of 10×10 dots is imprinted with a laser marker that can record dots each having a size of 25 μm, for example.

Therefore, in terms of the size of the information recording region that is a square-shaped region, it is necessary to take into consideration a quiet zone to be used for distinguishing the two-dimensional code from the peripheral circuit pattern, the accuracy in positioning the laser marker, and the likes, as well as the size of the two-dimensional code, which is 250×250 μm².

However, when the semiconductor device disclosed in Japanese Patent Application Laid-open No. 5-315207 is designed, the size of each semiconductor chip becomes larger, as the square-shaped region in which a two-dimensional code is to be imprinted is secured. At the same time, the number of semiconductor chips that can be obtained from each semiconductor wafer becomes smaller.

If the size of the square-shaped region that can be maintained is smaller than the size of the two-dimensional code in a conventional semiconductor chip, the two-dimensional code cannot be imprinted on the semiconductor chip.

There has been a method of generating two-dimensional codes from pieces of information obtained by dividing information to be imprinted (see Japanese Patent Application Laid-open No. 2004-206447, for example).

In the two-dimensional coding device disclosed in Japanese Patent Application Laid-open No. 2004-206447, the input information is divided, and each of the pieces of information obtained through the dividing is converted into a two-dimensional code to obtain several two-dimensional codes.

When those two-dimensional codes are imprinted in square-shaped regions formed on the semiconductor chip, the size of each two-dimensional code becomes smaller, and accordingly, the information recording region can be readily secured.

However, each two-dimensional code needs to include an alignment pattern, a clock pattern, and a quiet zone. As a result, the information recording region becomes larger in total.

### SUMMARY OF THE INVENTION

A semiconductor according to a first aspect of the present invention includes: a first region in which an integrated circuit is formed; and a second region in which a plurality of patterns formed by dividing a two-dimensional code of ID information are imprinted.

A method of manufacturing a semiconductor device according to a second aspect of the present invention includes: forming an integrated circuit in a first region of each rectangular region that includes the first region and a second region, and is surrounded by dicing lines formed in a lattice-like shape on a principal face of a semiconductor wafer; dividing a two-dimensional code of ID information into a plurality of patterns, based on division information as to the two-dimensional code; imprinting the plurality of patterns in the second region of the rectangular region, based on arrangement information as to the plurality of patterns; and dicing the semiconductor wafer along the dicing lines, thereby separating chips from one another.

An information managing system for a semiconductor device according to a third aspect of the present invention includes: a two-dimensional code imprinting device that includes: a two-dimensional coding unit that converts ID information into a two-dimensional code; a two-dimensional code dividing unit that divides the two-dimensional code into a plurality of patterns, based on division information as to the two-dimensional code; and a pattern imprinting unit that imprints the plurality of patterns in a plurality of regions on a semiconductor device, based on arrangement information as to the plurality of patterns; a two-dimensional code reading device that includes: a pattern acquiring unit that acquires the plurality of patterns imprinted on the semiconductor chip, based on the arrangement information as to the plurality of patterns; a two-dimensional code restoring unit that unites the plurality of patterns, based on the division information as to the two-dimensional code, so as to restore the two-dimensional code; and a decoding unit that decodes the two-dimensional code to output the ID information; and a managing unit that manages a production history of the semiconductor device, based on the ID information.

### BRIEF DESCRIPTION OF THE DRAWINGS

FIGS. 1(a) and 1(b) are diagrams showing a semiconductor device according to a first embodiment of the present invention: FIG. 1(a) is a plan view showing a semiconductor chip having an ID mark imprinted thereon; and FIG. 1(b) is a diagram showing a two-dimensional code of ID information that is the base of the ID mark shown in FIG. 1(a);

FIG. 2 is a flowchart of the method of dividing and imprinting the two-dimensional code of the ID information onto the semiconductor device according to the first embodiment of the present invention;

FIG. 3 is a diagram showing a division information as to the two-dimensional code according to the first embodiment of the present invention;

FIG. 4 is a diagram showing an arrangement information as to the patterns according to the first embodiment of the present invention;

FIG. 5 is a flowchart of the method of restoring the two-dimensional code from the patterns imprinted on the semiconductor device according to the first embodiment of the present invention;

FIGS. 6(a) to 6(f) are diagrams sequentially showing the procedures for restoring the two-dimensional code according to the first embodiment of the present invention;

FIG. 7 is a diagram showing a semiconductor wafer on which semiconductor devices each having an ID mark imprinted thereon are formed according to the first embodiment of the present invention;

FIGS. 8(a) and 8(b) are diagrams showing a semiconductor device according to a second embodiment of the present invention: FIG. 8(a) is a plan view showing a semiconductor chip having an ID mark imprinted thereon; and FIG. 8(b) is a diagram showing a two-dimensional code of ID information that is the base of the ID mark shown in FIG. 8(b);

FIG. 9 is a block diagram showing the structure of an information managing system for semiconductor devices according to a third embodiment of the present invention;

FIG. 10 is a diagram showing an image of an imprinted pattern according to the third embodiment of the present invention;

FIGS. 11(a) and 11(b) are diagrams showing a three-dimensional image of dots that form the imprinted pattern according to the third embodiment of the present invention: FIG. 11(a) is a diagram showing an image of the dots seen obliquely from above; and FIG. 11(b) is a diagram showing an image of the dots seen obliquely from below; and

FIG. 12 is a diagram showing a two-dimensional code (a data cell) restored from image data according to the third embodiment of the present invention.

### DETAILED DESCRIPTION OF THE INVENTION

The following is a description of embodiments of the present invention, with reference to the accompanying drawings.

(First Embodiment)

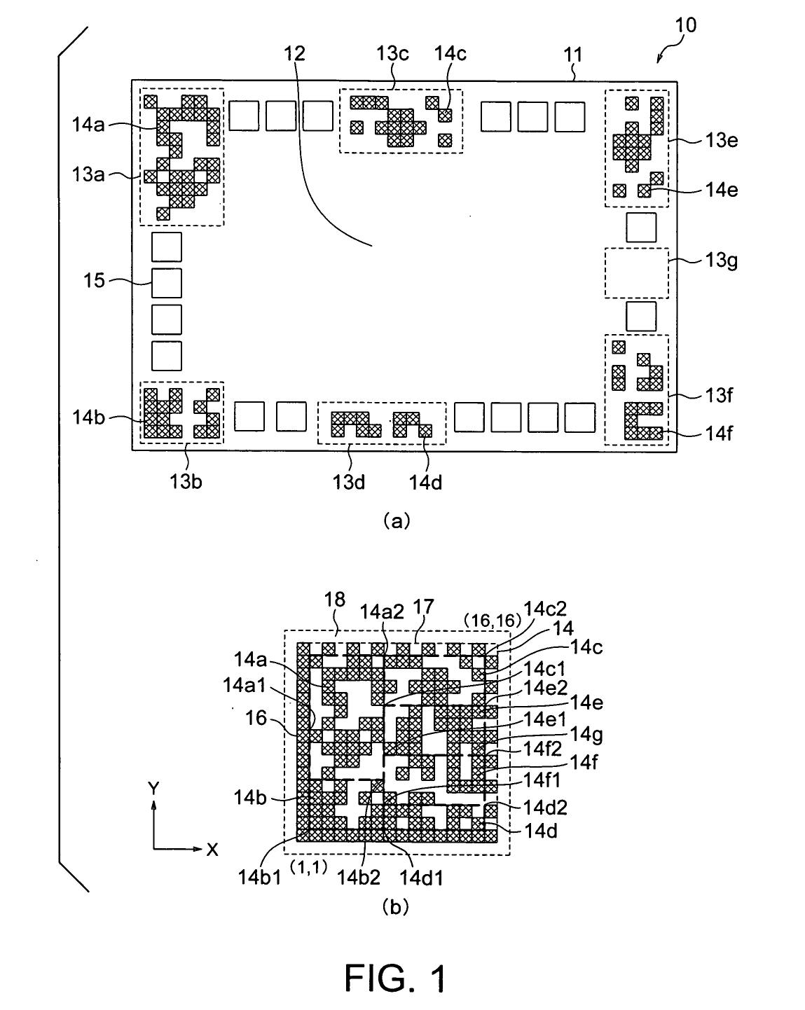

FIGS. 1(a) and 1(b) are diagrams showing a semiconductor device according to a first embodiment of the present invention. FIG. 1(a) is a plan view showing a semiconductor chip having an ID mark imprinted thereon. FIG. 1(b) is a diagram showing the two-dimensional code of the ID information that is the base of the ID mark shown in FIG. 1(a). In this embodiment, the two-dimensional code is a data matrix.

As shown in FIG. 1(a), a semiconductor device 10 of this embodiment includes a first region 12 in which an integrated circuit (not shown) is formed on a semiconductor chip 11, and second regions 13a to 13g as open areas in which no integrated circuits are formed.

The integrated circuit in the first region 12 may include a logic circuit (not shown) and connecting pads 15 for inputting data from the outside and outputting logic operation results to the outside, for example.

The ID information may include the production lot number of the semiconductor device 10, the number allotted to the used semiconductor wafer, the information as to the location of the semiconductor chip 11 in the wafer, and other information necessary for management.

As shown in FIG. 1(b), the two-dimensional code 14 of the ID information is formed with 16×16 cells, and includes a data cell 14g, an L-shaped alignment pattern 16, and a clock pattern 17 having white cell and black cells alternately arranged.

The alignment pattern 16 and the clock pattern 17 are located at the sides, and the region surrounded by the alignment pattern 16 and the clock pattern 17 is the data cell 14g.

Further, a quiet zone 18 that serves as a margin of one cell in width is provided around the two-dimensional code 14.

Patterns 14a to 14f that are formed by dividing the data cell 14g of the two-dimensional code 14 of the ID information are imprinted in each of the second regions 13a to 13f of the second regions 13a to 13g.

Meanwhile, the second region 13g is a blank region in which any divided pattern of the two-dimensional code 14 of the ID information is not imprinted.

The area of each of the second regions 13a to 13g is smaller than the area of the two-dimensional code 14, and the total sum of the areas of the regions 13a to 13g is larger than the area of the two-dimensional code 14.

Accordingly, it is not possible to imprint the two-dimensional code 14 directly onto each of the second regions 13a to 13g, but the two-dimensional code 14 is divided and distributed across the second regions 13a to 13g.

Here, since the alignment pattern 16 and the clock pattern 17 of the two-dimensional code 14 are fixed patterns and do not contain the ID information, only the data cell 14g, exclusive of the alignment pattern 16 and the clock pattern 17, is divided into the patterns 14a to 14f in conformity with the areas of the second regions 13a to 13g.

More specifically, the two-dimensional code 14 is divided so that the pattern 14a of 6×10 cells is formed according to the area of the second region 13a, the pattern 14b of 6×4 cells is formed according to the area of the second region 13b, the pattern 14c of 8×4 cells is formed according to the area of the second region 13c, the pattern 14d of 8×2 cells is formed according to the area of the second region 13d, the pattern 14e of 4×8 cells is formed according to the area of the second region 13e, and the pattern 14f of 4×8 cells is formed according to the area of the second region 13f.

In a case where a new semiconductor chip 11 is designed with this structure, only the data cell 14g is divided in several patterns, and is distributed in several regions, so that the two-dimensional code 14 can be arranged on a semiconductor device with a minimum space.

Even if an existing semiconductor chip 11 does not have a space in which the two-dimensional code 14 can be imprinted, the two-dimensional code 14 can be formed on the semiconductor chip 11, as long as regions having a larger total area than the area of the data cell 14g are secured.

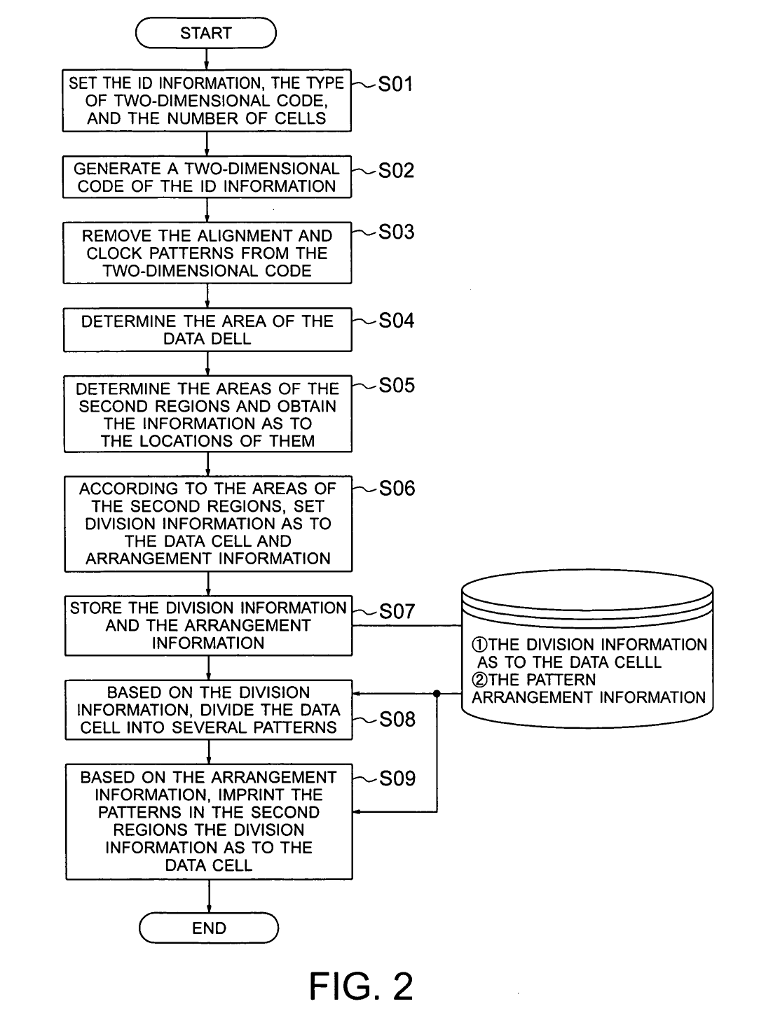

Referring now to FIGS. 2 to 4, the method of dividing the two-dimensional code 14 of the ID information in several patterns and imprinting it onto the semiconductor chip 11 is described.

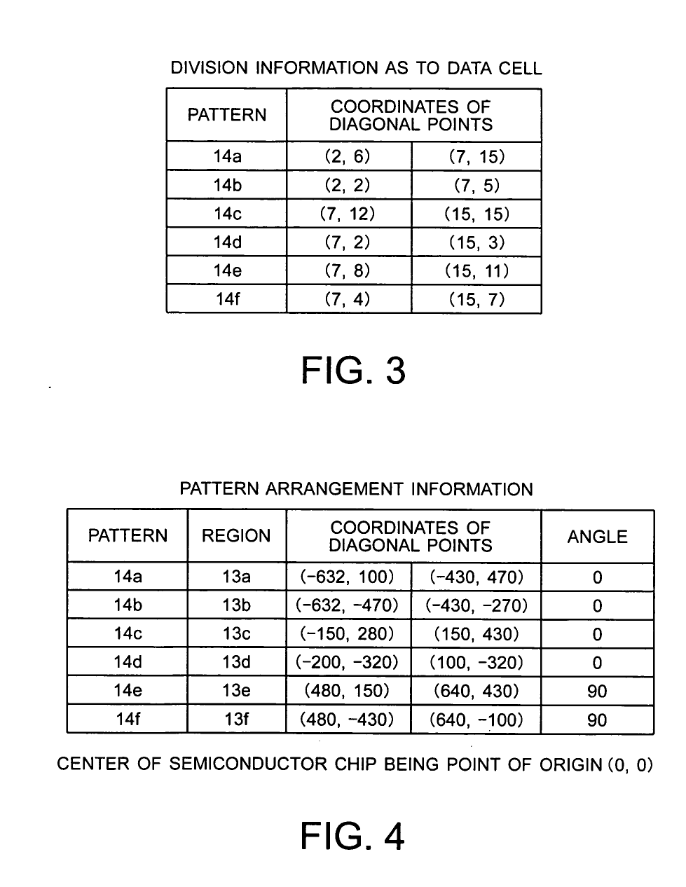

FIG. 2 is a flowchart showing the imprinting method. FIG. 3 is a diagram showing the division information to be used for dividing the two-dimensional code 14. FIG. 4 is a diagram showing the arrangement information to be used for arranging the patterns onto the semiconductor chip on which an integrated circuit is formed.

As shown in FIG. 2, when ID information is set, the type of a two-dimensional code, the number of cells, and the likes to be used are set according to the volume of the ID information (step S01).

The ID information is then coded two-dimensionally to generate two-dimensional code 14 (step S02). The alignment pattern 16 and the clock pattern 17 are subtracted from the two-dimensional code 14 (step S03), so as to determine the area of the data cell 14g (step S04).

The areas and position information of the second regions 13a to 13g on the semiconductor chip 11 are then determined (step S05).

According to the areas of the second regions 13a to 13g, the division information as to the data cell and the arrangement information as to the divided patterns are determined (step S06), and the results of them are stored (step S07).

As shown in FIG. 3, the division information as to the data cell may contain the coordinates of the diagonal points of the patterns 14a to 14f obtained by dividing the data cell 14g, for example.

More specifically, the coordinates of the diagonal points 14a1 and 14a2 of the pattern 14a are (2, 6) and (7, 15), the coordinates of the diagonal points 14b1 and 14b2 of the pattern 14b are (2, 2) and (7, 5), the coordinates of the diagonal points 14c1 and 14c2 of the pattern 14c are (7, 12) and (15, 15), the coordinates of the diagonal points 14d1 and 14d2 of the pattern 14d are (7, 2) and (15, 3), the coordinates of the diagonal points 14e1 and 14e2 of the pattern 14e are (7, 8) and (15, 11), and the coordinates of the diagonal points 14f1 and 14f2 of the pattern 14f are (7, 4) and (15, 7), as shown in FIGS. 1(b) and 3.

As shown in FIG. 4, the arrangement information as to the patterns may contain the coordinates of the diagonal points of the second regions 13a to 13f in which the patterns 14a to 14f are to be arranged, and the angles of the patterns 14a to 14f with respect to the coordinate axis, for example.

More specifically, with the center of the semiconductor chip 11 being the origin of coordinates (0, 0), the coordinates of the diagonal points of the second region 13a are shown as (−632, 100) and (−430, 470), the coordinates of the diagonal points of the second region 13b are shown as (−632, −470) and (−430, −270), the coordinates of the diagonal points of the second region 13c are shown as (−150, 280) and (150, 430), the coordinates of the diagonal points of the second region 13d are shown as (−200, −320) and (100, −320), the coordinates of the diagonal points of the second region 13e are shown as (480, 150) and (640, 430), and the coordinates of the diagonal points of the second region 13f are shown as (480, −430) and (640, −100).

The patterns 14a to 14d at the angle of 0 degrees are arranged in parallel with the coordinate axis in the second regions 13a to 13d, respectively. The patterns 14e and 14f are rotated through 90 degrees counterclockwise and are placed in the second regions 13e and 13f.

Based on the division information as to the data cell, the data cell 14g is divided into the patterns 14a to 14f (step S08). Based on the arrangement information as to the patterns, the patterns 14a to 14f are imprinted with a laser marker, for example (step S09).

In this embodiment, after an integrated circuit is formed on a semiconductor wafer, a two-dimensional code of ID information is divided into several patterns, based on the division information as to the two-dimensional code. However, it is also possible to divide the two-dimensional code prior to the formation of the integrated circuit. Also, in this embodiment, the imprinting of the two-dimensional code is performed after the formation of the integrated circuit. However, the two-dimensional code may be imprinted before the integrated circuit is formed.

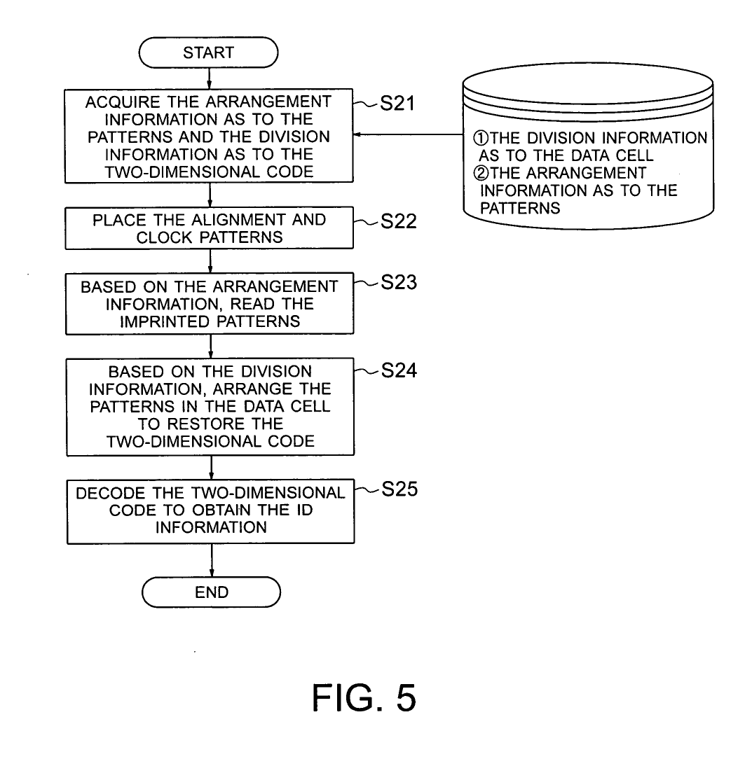

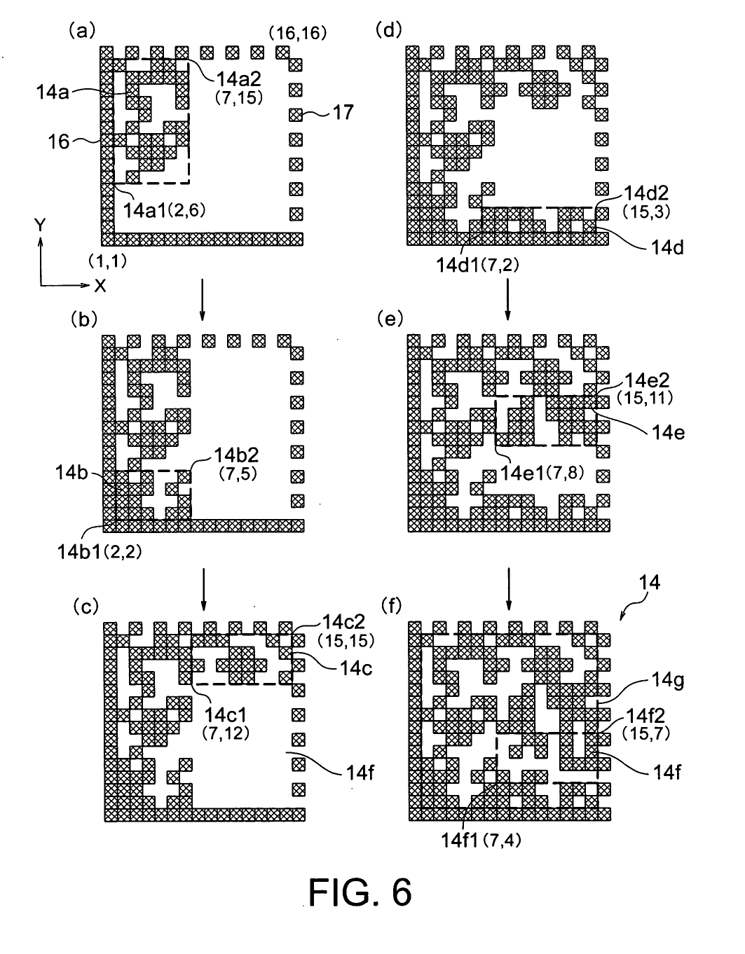

Referring now to FIG. 5 and FIGS. 6(a) to 6(f), a method of restoring the two-dimensional code 14 from the semiconductor chip 11 having the patterns 14a to 14f imprinted thereon and thus reading the ID information is described.

As shown in FIG. 5, the arrangement information as to the stored patterns and division information as to the data cell are acquired (step S21). The alignment pattern 16 and the clock pattern 17 are placed at the sides so as to maintain the region in which the data cell is to be placed, and the coordinate axis is set (step S22).

Based on the arrangement information as to the patterns, the patterns 14a to 14f are sequentially read as image patterns from the second regions 13a to 13f with a digital camera, for example (step S23).

Based on the division information as to the data cell, the read patterns 14a to 14f are arranged in the coordinate positions of the diagonal points of the respective patterns, so as to unit the patterns 14a to 14f . Thus, the two-dimensional code 14 is restored (step S24).

More specifically, the L-shaped alignment pattern 16 is placed at the left and bottom sides, and the clock pattern 17 is placed at the right and top sides, as shown in FIG. 6(a).

With this arrangement, the coordinate axis having the point of origin located at the intersecting point of the L-shaped pattern is set. The pattern 14a that is first read is placed in such a position that the coordinates of the diagonal points 14a1 and 14a2 of the pattern 14a become (2, 6) and (7, 15).

As shown in FIGS. 6(b) to 6(f), the pattern 14b is placed in such a position that the coordinates of the diagonal points 14b1 and 14b2 of the pattern 14b become (2, 2) and (7, 5), the pattern 14c is placed in such a position that the coordinates of the diagonal points 14c1 and 14c2 of the pattern 14c become (7, 12) and (15, 15), the pattern 14d is placed in such a position that the coordinates of the diagonal points 14d1 and 14d2 of the pattern 14d become (7, 2) and (15, 3), the pattern 14e is placed in such a position that the coordinates of the diagonal points 14e1 and 14e2 of the pattern 14e become (7, 8) and (15, 11), and the pattern 14f is placed in such a position that the coordinates of the diagonal points 14f1 and 14f2 of the pattern 14f become (7, 4) and (15, 7). In this manner, the data cell 14g is restored.

Thus, the two-dimensional code 14 including the data cell 14g, the alignment pattern 16, and the clock pattern 17 is restored. The restored two-dimensional code 14 is decoded to obtain the ID information (step S25).

Accordingly, with the division information indicating how the two-dimensional code 14 is divided and the arrangement information indicating which parts of the semiconductor chip 11 the divided patterns are imprinted, the original two-dimensional code 14 can be restored.

Next, a method of manufacturing the semiconductor device 10 having the divided patterns 14a to 14f of the two-dimensional code 14 of the ID information imprinted thereon is described.

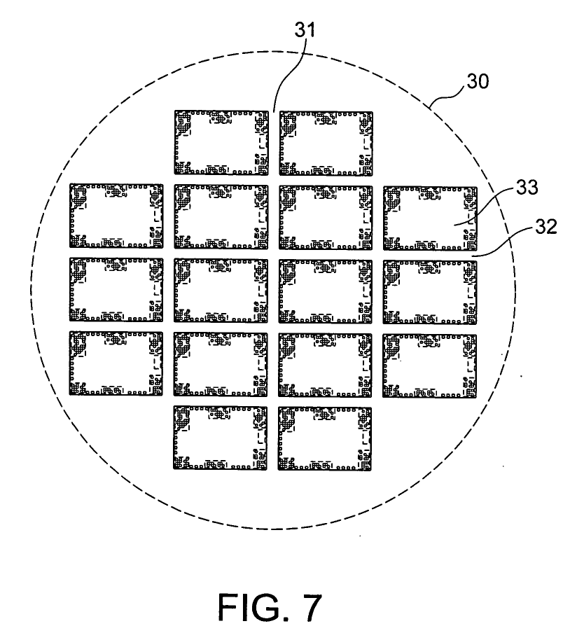

As shown in FIG. 7, an integrated circuit is formed in the first region 12 of each device formation region 33 surrounded by lattice-like dicing lines 31 and 32 on a semiconductor wafer 30.

The two-dimensional code 14 of the ID information is then divided into the patterns 14a to 14f, based on the division information as to the two-dimensional code shown in FIG. 3. The divided patterns 14a to 14f are imprinted in the second regions 13a to 13f in each device formation region 33 with a laser marker or the like, based on the arrangement information as to the patterns shown in FIG. 4.

The semiconductor wafer 30 is then divided along the dicing lines 31 and 32. Thus, the semiconductor chip 11 with the two-dimensional code 14 shown in FIG. 1(b) can be obtained.

As described above, the two-dimensional code 14 of the ID information is divided into the patterns 14a to 14f, and the divided patterns 14a to 14f are imprinted in the regions 13a to 13f on the semiconductor chip 11. Thus, the two-dimensional code 14 can be provided even in a small area.

Accordingly, when new semiconductor devices are designed, each semiconductor chip 11 can be made smaller in size.

Even if a semiconductor device does not have a space in which the two-dimensional code 14 can be imprinted directly, the two-dimensional code 14 can be provided as long as the semiconductor device has regions having a total area that is larger than the area of the data cell.

Thus, small-sized semiconductor devices each having an ID mark imprinted thereon can be provided.

Since the arrangement information as to the patterns and the division information as to the data cell are needed to restore the two-dimensional code 14, secrecy can be given to each semiconductor device so that one cannot obtain the ID information unless he/she has the arrangement information as to the patterns and the division information as to the data cell.

Although the patterns 14a to 14f are formed only from the data cell 14g of the two-dimensional code 14 in the above description, the alignment pattern 16 and the clock pattern 17 may be included in the patterns 14a to 14f if there is enough space to spare in the second regions.

Further, the data cell 14g of the two-dimensional code 14 is divided into the rectangular patterns 14a to 14f in the above description. However, it is possible to divide the data cell 14g into patterns of some other shapes. For example, the patterns 14a to 14f may include an L-shaped pattern or a cross-like pattern according to the area of each second region.

If there is a second region that might adversely affect the characteristics of the integrated circuit when a pattern is imprinted therein, the second region should preferably be removed.

(Second Embodiment)

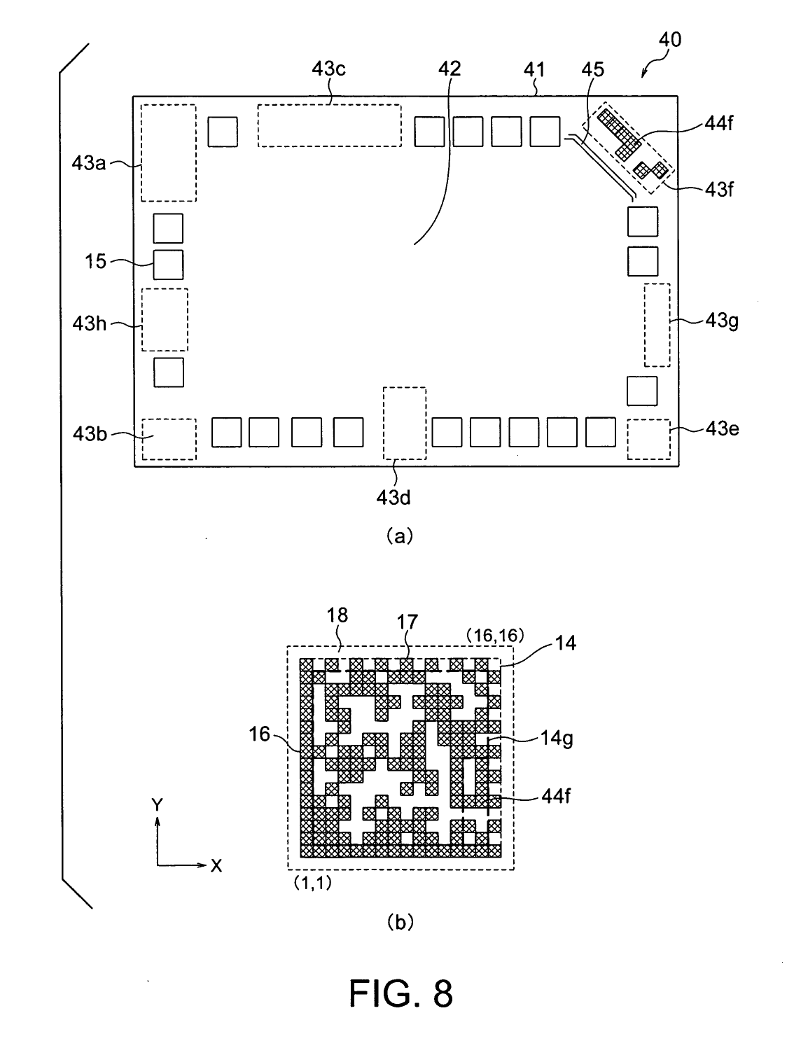

FIGS. 8(a) and 8(b) are diagrams showing a semiconductor device according to a second embodiment of the present invention. FIG. 8(a) is a plan view showing a semiconductor chip having an ID mark imprinted thereon. FIG. 8(b) is a diagram showing the two-dimensional code of the ID information that is the base of the ID mark shown in FIG. 8(a).

In the description of this embodiment, the same components as those of the first embodiment are denoted by the same reference numerals as those of the first embodiment, and explanation of them is omitted. The aspects of this embodiment that are different from the first embodiment are described below.

This embodiment differs from the first embodiment in that an ID mark is provided in a second region that is positioned diagonally with respect to the dicing directions of the semiconductor chip.

More specifically, a semiconductor device 40 of this embodiment includes a first region 42 and second regions 43a to 43h on a semiconductor chip 41, as shown in FIG. 8(a).

The second regions 43a to 43e, 43g, and 43h are located in parallel with the dicing directions of the semiconductor chip 41.

Meanwhile, the second region 43f is located in parallel with a wire 45 that is placed diagonally with respect to the dicing directions of the semiconductor chip 41.

The placement of wires and devices is restrained at the sides and the four corners of the semiconductor chip 11, so as to prevent adverse influence (such as chipping and stress) of the dicing and resin sealing procedures in a case where the circuit pattern of the semiconductor device 40 is designed. As a result, the oblique second region 43f might be formed at each of the four corners.

In the second regions 43a to 43e, patterns (not shown) that are formed by dividing the two-dimensional code 14 of the ID information are imprinted in the dicing direction of the semiconductor chip 41.

Meanwhile, in the second region 43f, a pattern 44f that is formed by dividing the two-dimensional code 14 of the ID information is imprinted diagonally with respect to the dicing direction of the semiconductor chip 41.

The second regions 43g and 43h are blank regions in which no patterns formed by dividing the two-dimensional code 14 of the ID information are imprinted.

The second regions 43f, 43g, and 43h have spaces in which patterns of 2×8 cells, 1×6 cells, and ×4 cells can be imprinted, respectively. The pattern 44f is formed with 2×7 cells, and therefore, it is most preferable to imprint the pattern 44f in the second region 43f.

By imprinting the pattern 44f in the second region 43f, the number of divided patterns can be made smaller than in a case where the pattern 44f is further divided into patterns of 1×3 cells and 2×4 cells to be imprinted in the second region 43g and the second region 43h, respectively.

The second region located diagonally with respect to the dicing direction of the semiconductor chip can be indicated by the angles of gradient with respect to the coordinates of the diagonal points and the dicing direction of the semiconductor chip in the arrangement information as to the patterns shown in FIG. 4.

As described above, this embodiment is advantageous in that the number of divided patterns of the two-dimensional code 14 of the ID information can be reduced by imprinting a pattern in an oblique region with a large area in the case where the second region 43f located diagonally with respect to the dicing direction of the semiconductor chip 41 coexists with the second regions 43g and 43h having smaller areas than the second region 43f.

(Third Embodiment)

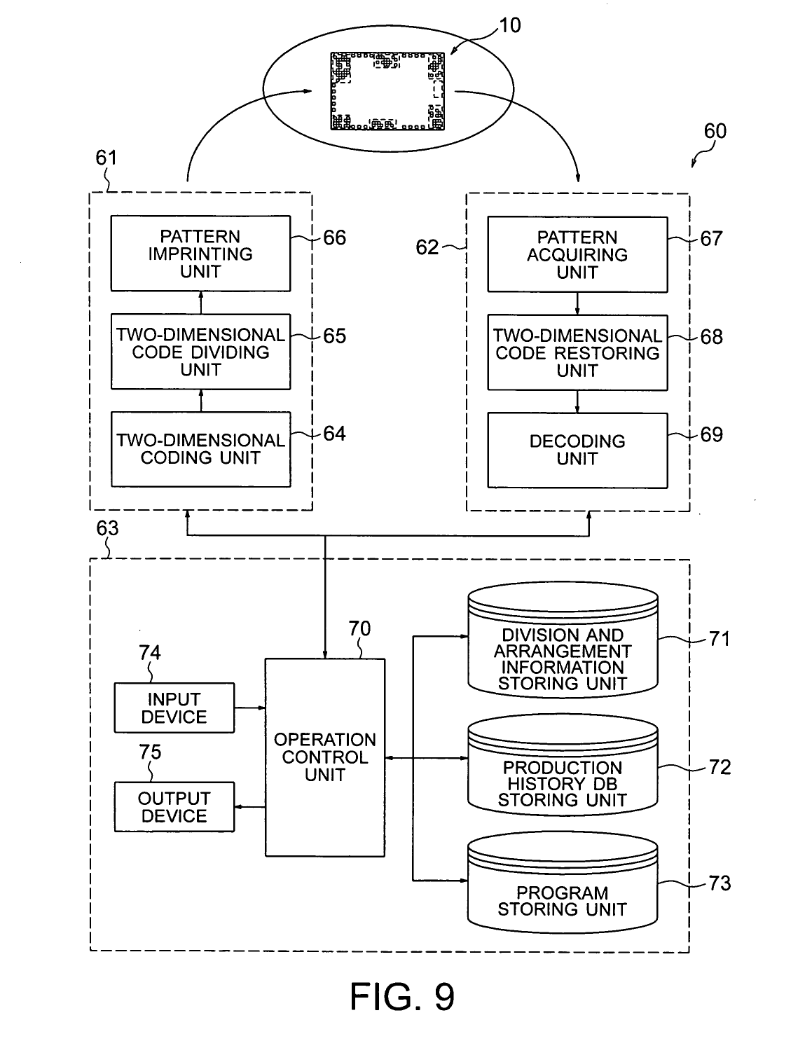

FIG. 9 is a block diagram showing the structure of an information managing system for semiconductor devices according to a third embodiment of the present invention.

This embodiment is to manage information such as the production history of each semiconductor device by imprinting patterns that are formed by dividing a two-dimensional code of ID information in the semiconductor device of the first or second embodiment and reading the imprinted patterns to restore the ID information.

As shown in FIG. 9, an information managing system 60 for semiconductor devices of this embodiment includes: a two-dimensional code imprinting device 61 that divides a two-dimensional code of ID information into patterns and imprints the divided patterns in each semiconductor device; a two-dimensional code reading device 62 that reads the imprinted patterns to restore the two-dimensional code, and then decodes the two-dimensional code to output the ID information; and a managing unit 63 that manages the production history of each semiconductor device, based on the ID information.

The two-dimensional code imprinting device 61 includes: a two-dimensional coding unit 64 that converts ID information into a two-dimensional code; a two-dimensional code dividing unit 65 that divides the two-dimensional code into patterns, based on division information as to the two-dimensional code; and a pattern imprinting unit 66 that imprints the divided patterns in regions on a semiconductor device, based on arrangement information as to the patterns.

The two-dimensional code reading device 62 includes: a pattern acquiring unit 67 that acquires the patterns imprinted on the semiconductor device, based on the arrangement information as to the patterns; a two-dimensional code restoring unit 68 that unites the patterns, based on the division information as to the two-dimensional code, so as to restore the two-dimensional code; and a decoding unit 69 that decodes the two-dimensional code to output the ID information.

The managing unit 63 includes: an operation control unit 70 that commands a series of operations of the two-dimensional code imprinting device 61 and the two-dimensional code reading device 62 and has the means of controlling the operation of the entire system; a division and arrangement information storing unit 71 that stores the division information as to the two-dimensional code and the arrangement information as to the patterns; a production history DB storing unit 72 that stores the database of the production history of each semiconductor device; and a program storing unit 73 that stores a program for controlling a series of operations of the operation control unit 70.

The managing unit 63 further includes: an input device 74 that inputs the ID information such as the production lot number and the wafer number of each semiconductor device and the information as to the location of the semiconductor chip in the wafer; and an output device 75 that outputs information such as the production history that is detected based on ID information.

The division and arrangement information storing unit 71, the production history DB storing unit 72, and the program storing unit 73 may be partially formed with the main storage unit in a computer, or may be formed with a storage medium connected to the computer, such as a semiconductor memory, a magnetic disk, a magnetic tape, or an optical disk.

The operation control unit 70 constitutes a part of the central processing unit of a computer system, and operates under the control of the computer system of an integrated processing type or a distributed processing type.

Using a laser marker, the pattern imprinting unit 66 imprints patterns each formed with dots having a concave middle portion by adjusting the power of the laser to be emitted.

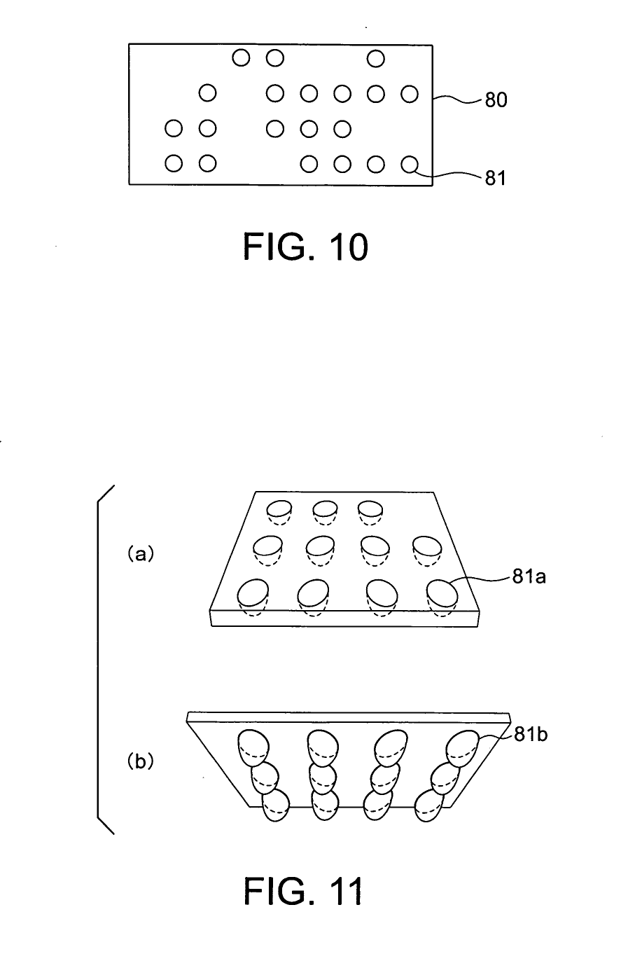

FIG. 10 is an image showing a pattern 80 imprinted by the pattern imprinting unit 66. In this image, the black cots are the concave dots 81.

FIGS. 11(a) and 11(b) are diagrams showing three-dimensional images of the dots 81 forming the pattern 80. FIG. 11(a) shows an image of dots 81a seen obliquely from above. FIG. 11(b) shows an image of dots 81b seen obliquely from below.

The pattern acquiring unit 67 acquires the imprinted patterns 14a to 14f as image data, using a digital camera equipped with a microscope.

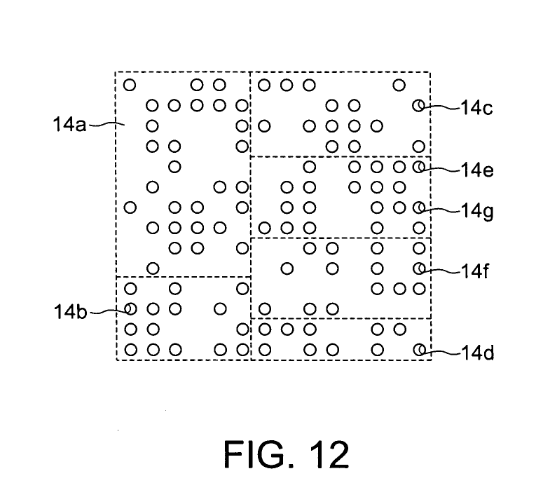

FIG. 12 is a diagram showing the data cell 14g restored from the image data of the patterns 14a to 14f.

As described above, according to this embodiment, information such as the production history of a small-sized semiconductor device having an ID mark can be readily managed.

In the above description, the information managing system 60 is an online system that integrates the two-dimensional code imprinting device 61, the two-dimensional code reading device 62, and the managing unit 63. However, they may operation independently of one another as an offline system.

As described so far as the embodiments of the present invention, a small-sized semiconductor device having an ID mark, a method of manufacturing such a semiconductor device, and an information managing system for such a semiconductor device can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A semiconductor device comprising:
a first region in which an integrated circuit is formed; and
a second region in which a plurality of patterns formed by dividing a two-dimensional code of ID information are imprinted.

2. The semiconductor device according to claim 1, wherein the plurality of patterns are formed only from a data cell of the two-dimensional code.

3. The semiconductor device according to claim 1, wherein:
the second region includes a plurality of regions each having a smaller area than the area of the two-dimensional code; and
the total sum of the areas of the plurality of regions is larger than the area of the two-dimensional code.

4. The semiconductor device according to claim 1, wherein the second region is located at the sides or corners of a semiconductor chip.

5. A method of manufacturing a semiconductor device, comprising:
forming an integrated circuit in a first region of each rectangular region that includes the first region and a second region, and is surrounded by dicing lines formed in a lattice-like shape on a principal face of a semiconductor wafer;
dividing a two-dimensional code of ID information into a plurality of patterns, based on division information as to the two-dimensional code;
imprinting the plurality of patterns in the second region of the rectangular region, based on arrangement information as to the plurality of patterns; and
dicing the semiconductor wafer along the dicing lines, thereby separating chips from one another.

6. The method of manufacturing a semiconductor device according to claim 5, wherein the plurality of patterns are formed only from a data cell of the two-dimensional code.

7. The method of manufacturing a semiconductor device according to claim 5, wherein:
the second region includes a plurality of regions each having a smaller area than the area of the two-dimensional code; and
the total sum of the areas of the plurality of regions is larger than the area of the two-dimensional code.

8. The method of manufacturing a semiconductor device according to claim 5, wherein the second region is located at sides or corners of a semiconductor chip.

9. The method of manufacturing a semiconductor device according to claim 5, wherein the division information as to the two-dimensional code contains the coordinates of the diagonal points of the divided patterns.

10. The method of manufacturing a semiconductor device according to claim 5, wherein the arrangement information as to the plurality of patterns contains the coordinates of the diagonal points of the second region in which the plurality of patterns are to be placed, and the angles of the plurality of patterns with respect to a coordinate axis.

11. An information managing system for a semiconductor device, comprising:
a two-dimensional code imprinting device that includes: a two-dimensional coding unit that converts ID information into a two-dimensional code; a two-dimensional code dividing unit that divides the two-dimensional code into a plurality of patterns, based on division information as to the two-dimensional code; and a pattern imprinting unit that imprints the plurality of patterns in a plurality of regions on a semiconductor device, based on arrangement information as to the plurality of patterns;
a two-dimensional code reading device that includes: a pattern acquiring unit that acquires the plurality of patterns imprinted on the semiconductor chip, based on the arrangement information as to the plurality of patterns; a two-dimensional code restoring unit that unites the plurality of patterns, based on the division information as to the two-dimensional code, so as to restore the two-dimensional code; and a decoding unit that decodes the two-dimensional code to output the ID information; and
a managing unit that manages a production history of the semiconductor device, based on the ID information.

12. The information managing system for a semiconductor device according to claim 11, wherein the division information as to the two-dimensional code contains the coordinates of the diagonal points of the divided patterns.

13. The information managing system for a semiconductor device according to claim 11, wherein the arrangement information as to the plurality of patterns contains the coordinates of the diagonal points of the second region in which the plurality of patterns are to be placed, and the angles of the plurality of patterns with respect to a coordinate axis.

14. The information managing system for a semiconductor device according to claim 11, wherein the plurality of patterns are formed only from the data cell of the two-dimensional code.
